(19) United States
(12) Patent Application Publication
(10) Pub. No.: US 2008/0003088 A1
(43) Pub. Date: Jan. 3, 2008

(54) Adjustable Schnable

(76) Inventor: Brian Banta, Walcott, IA (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/479,058

(22) Filed: Jun. 30, 2006

(51) Int. Cl. B60P 3/00

(52) U.S. Cl. 414/460

(57) ABSTRACT

An adjustable schnable system in which the ride height of the transport object may be adjusted by the operator is disclosed and claimed. The adjustable schnable is comprised of a plurality of sections including front and rear portions having goosenecks and multiple axles therein. Vertical elevation of the goosenecks is controllable via hydraulic cylinders. Two pivotably adjustable arms are cooperatively engaged to both the front and rear goosenecks. Two v-type frames, having lateral beams, are pivotably mounted between and to each set of adjustable arms. The transport object, inserted between the two v-type frames, is held secure by compression forces. Raising the goosenecks causes the transport object to lift higher with respect to the adjustable schable system, rather than causing movement of the lateral beams of the vee-type frame in relation to the transport object. Control over the adjustable arms allows manipulation of the transport object ride height.

### FIELD OF INVENTION

The invention relates to trailers. The embodiments shown and described herein are more particularly for Schnable trailers for use with over-the-road tractor-trailer units for transporting wind generator tower sections.

### CROSS REFERENCE TO RELATED APPLICATIONS

None

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BRIEF DESCRIPTION OF THE DRAWINGS

FIG. 1 provides a side view of the adjustable Schnable with a transport object engaged with the Schnable.

FIG. 2A provides a top view of a portion of the adjustable Schnable.

FIG. 2B provides a top cross-sectional view of a portion of the adjustable Schnable.

FIG. 3 provides a detailed view of the front portion of the adjustable Schnable.

FIG. 4 provides a detailed view of the rear portion of the adjustable Schnable.

FIG. 5A provides a detailed view of the adjustable arm of a portion of one embodiment of the adjustable Schnable.

FIG. 5B provides a detailed view of the V-type frame.

FIG. 6 provides a detailed view of the mounting plate of one embodiment of the adjustable Schnable.

FIG. 7 provides an overview of the adjustable Schnable with the front and rear portions coupled together without a transport object.

### DETAILED DESCRIPTION-LISTING OF ELEMENTS

| Element Description | Element Number |
|---|---|
| Schnable System | 1 |
| V-type Frame | 2 |
| Adjustable Arm | 3 |
| Front Gooseneck | 4 |
| Rear Gooseneck | 5 |
| Hydraulic Cylinder | 6 |
| Front Jeep | 7 |
| Front Portion | 8A |
| Rear Portion | 8B |
| Front Gooseneck Foot | 9 |
| Rear Gooseneck Foot | 10 |
| Front Gooseneck Tower | 11 |
| Rear Gooseneck Tower | 12 |
| Inner Box-Shaped Member | 13 |
| Outer Box-Shaped Member | 14 |
| Base | 15 |
| Mounting Plate | 16 |
| Mounting Plate Bolt Hole | 17 |
| Mounting Plate Bolt | 18 |
| Base Slots | 19 |
| Mounting Plate Ear | 20 |
| Upper Pivot | 21 |
| Lower Pivot | 22 |
| Adjustable Arm Mount | 23 |
| Lateral Support Mount | 24 |
| Base Pivot | 25 |
| Pintle Hitch | 26 |
| Transport Object | 27 |
| | 28 |
| Chain Anchor | 29 |
| Multi-Axle Steering Dolly | 30 |
| Pin | 31 |
| Pin Hole | 32 |
| Turntable | 33 |
| Angled Support Beam | 34 |
| Lateral Support Beam | 35 |
| Wooden Pad | 36 |
| Base Mount | 37 |
| Fixed Axle | 38 |
| Rotatable Axle | 39 |

### DETAILED DESCRIPTION OF THE INVENTION

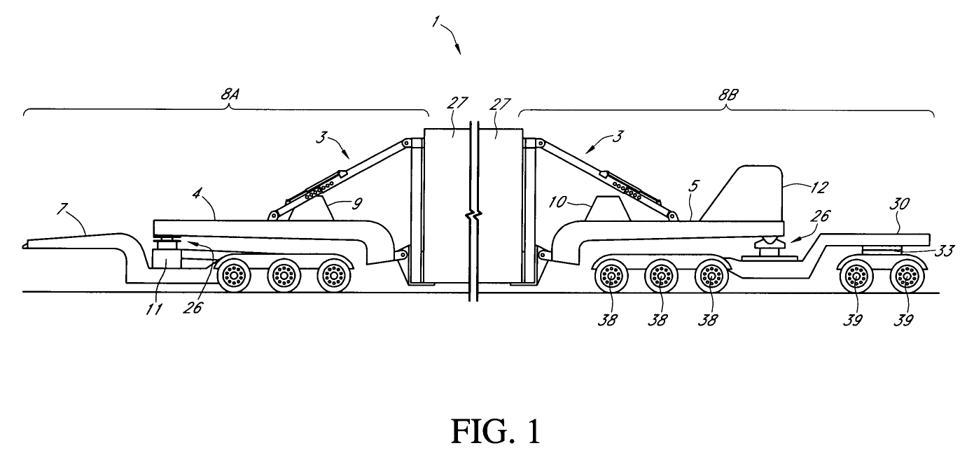

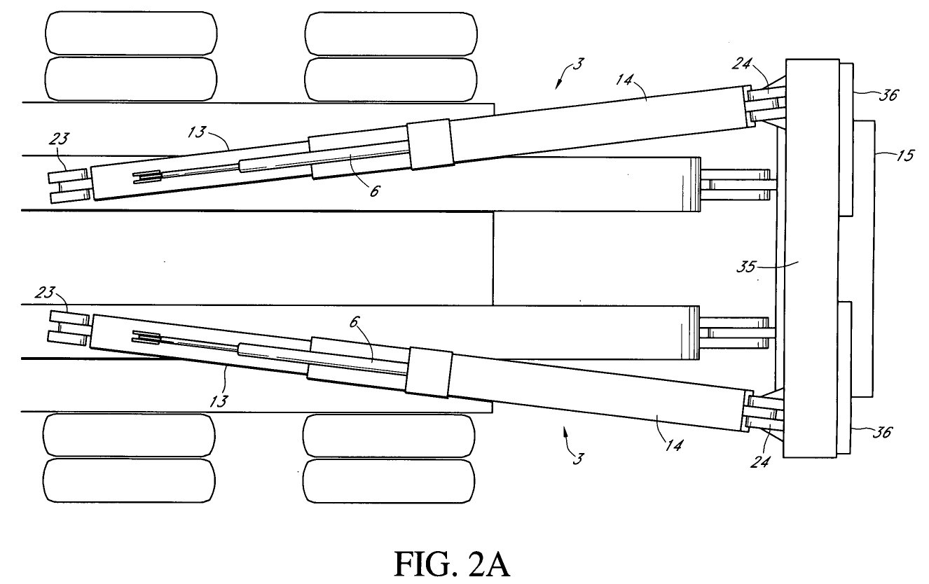

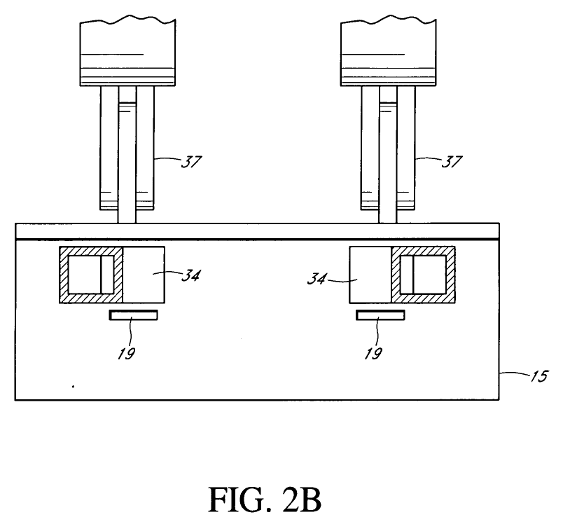

Referring now to the drawings, wherein like reference numerals designate identical or corresponding parts throughout the several views, FIGS. 1 and 2 disclose and describe an adjustable Schnable with a front portion 8A and a rear portion 8B. A Schnable as known to those skilled in the art is a trailer wherein the transport object 27 is attached to an axle structure at each end so that the front and rear axle structures are connected together only by the transport object 27, the general principle being well known to those skilled in the art. The embodiment disclosed and described herein is especially suited to the transport of large cylindrical transport objects 27, but improvements and derivations on the disclosed invention will become obvious to those skilled in the art without departing from the scope and spirit of the present invention. To improve presentation of the invention hydraulic hoses and associated plumbing or portions of the hydraulic systems described herein that are well known in the art are not shown.

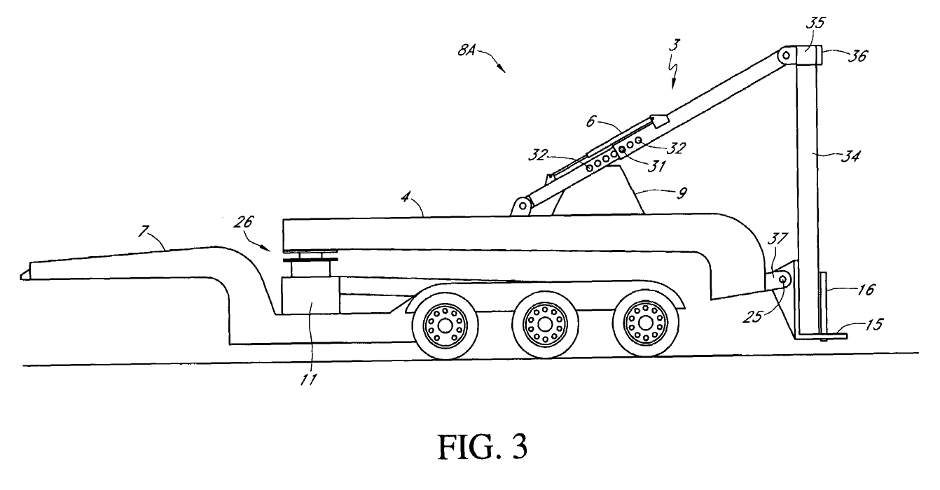

The invention described and disclosed herein provides for a Schnable in which the ride height of the transport object 27 may be adjusted as needed by the operator. The Schnable is comprised of two distinct sections, a front portion 8A and a rear portion 8B. In the embodiment shown in FIG. 3, a multi-axle front jeep 7, similar in function to a dolly and well known to those skilled in the art, is connected to a semi-tractor via a typical Pintle hitch 26 simultaneously pivotable about a substantially vertical and a substantially horizontal axis, also well known to those skilled in the art in the embodiment shown. Other Pintle type hitches, such as king pin or fifth wheel type may also be used but are not shown in the embodiment. The front jeep 7 is connected to the front gooseneck 4 via another typical Pintle hitch 26 pivotable about two distinct axes. The vertical elevation of the front of the front gooseneck 4 with respect to the front jeep 7 is controlled by the front gooseneck tower 11 via one or more hydraulic cylinders vertically mounted, as is well known to those skilled in the art. In the embodiment shown in FIGS. 1, 2 and 3, the front gooseneck tower 11 is positioned just ahead of the first axle on the front jeep 7 at the Pintle hitch 26, one means of coupling said front jeep 7 to a front gooseneck 4, as recited in the claims, connecting the front gooseneck 4 to the front jeep 7. The vertical elevation of the rear of the front gooseneck 4 with respect to the front jeep 7 is controlled by the front gooseneck foot 9 via one or more hydraulic cylinders vertically mounted to a foot that engages the front jeep 7 to fix the vertical relation between the rear of the front gooseneck 4 and the front jeep 7, which is also well known to those skilled in the art. In the embodiment shown in FIGS. 1, 2 and 3, the front gooseneck foot 9 is located approximately over the most rearward axle of the front jeep 7.

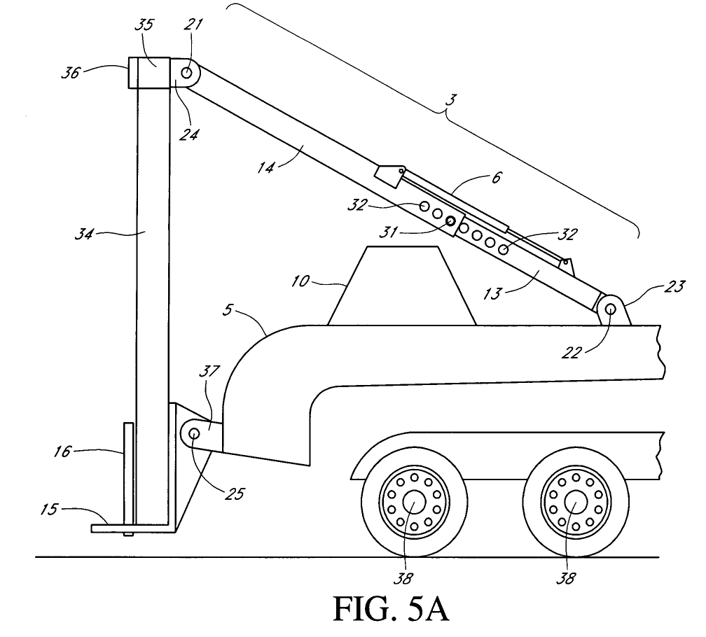

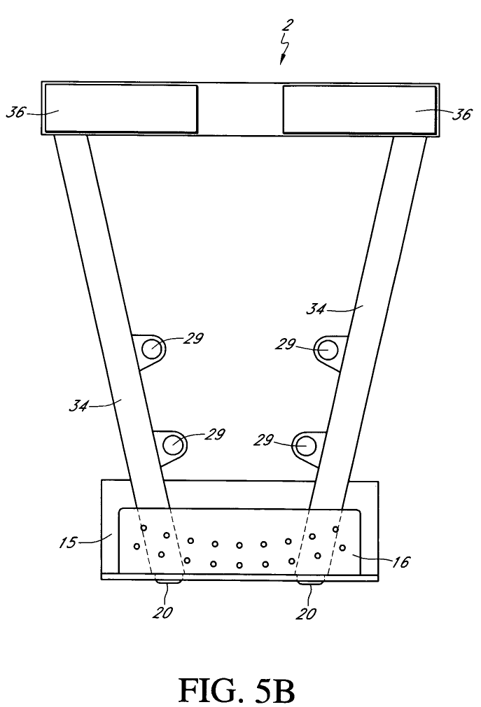

In the embodiment shown in FIGS. 1, 2 and 3, the front gooseneck 4 carries two adjustable arms 3 that are pivotably engaged (about a substantially horizontal axis) at one end with the front gooseneck 4 to form a lower pivot 22. In the embodiment shown in FIG. 5A, the adjustable arms 3 are formed by two box-shaped members, where an inner box-shaped member 13 is fitted inside an outer box-shaped member 14 and the inner box-shaped member 13 is slideable within the outer box shaped member 14 so that the length of the adjustable arms 3 is variable, one means of facilitating and adjustable arms 3, as recited in the claims. A plurality of corresponding pin holes 32 accept a pin 31 that when the pin 31 is inserted into corresponding pin holes 32, the position of the inner box-shaped member 13 is fixed relative to the position of the outer box-shaped member 14, thereby fixing the length of the adjustable arms 3. In the embodiment shown in FIG. 5A, one end of a hydraulic cylinder 6 is affixed to the outer box-shaped member 14 and the other end of the hydraulic cylinder 6 is affixed to the inner box-shaped member 13 so that when the pins 31 are not in place, actuation of the hydraulic cylinder moves the inner box-shaped member 13 with respect to the outer box-shaped member 14 and thereby adjusts the length of the adjustable arms 3. Adjustable arm mounts 23 are affixed to the front gooseneck 4 and provide the connection point between the front gooseneck 4 and the adjustable arms 3.

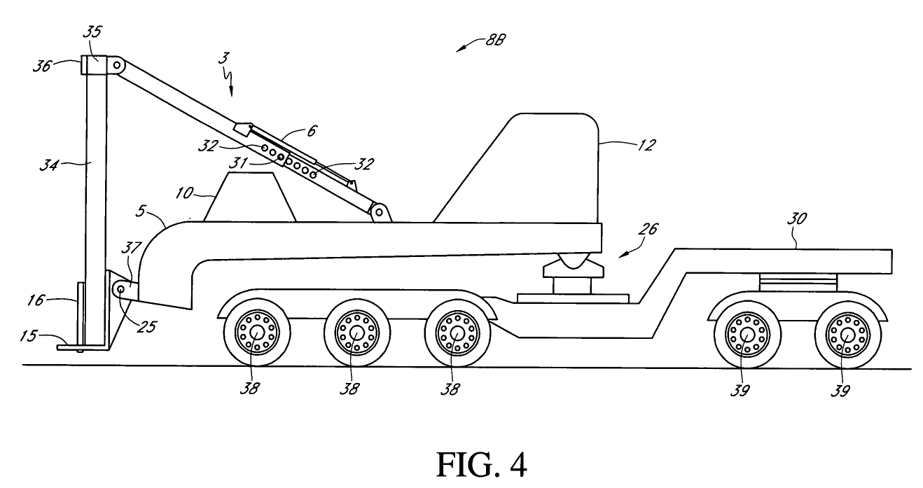

In the embodiment shown in FIGS. 1, 2 and 3, the inner box-shaped member 13 of the adjustable arms 3 is pivotably engaged about a substantially horizontal axis with the adjustable arm mounts 23 affixed to the front gooseneck 4 at the lower pivot 22 while the opposite end of the adjustable arms 3, the outer box-shaped member 14 in the embodiment shown in FIG. 5A, is pivotably engaged about a substantially horizontal axis with a lateral support beam 35 through lateral support mounts 24 affixed to the lateral support beam 35 to form an upper pivot 21. Therefore, each adjustable arm 3 is pivotably engaged at each end, which allows for easy adjustment of the length of the adjustable arms 3, one means of facilitating a pivotable engagement of V-type frames 21 to said front gooseneck 4 in combination with said lower base pivots. The lateral support beam 35 is affixed to one angled support beam 34 at its first end and another angled support beam 34 at its second end, as shown in FIG. 5B. In the embodiment shown in FIGS. 3 and 4, the side of the lateral support beam 35 that faces the transport object 27 incorporates wooden pads 36 affixed to the lateral support beam 35 to prevent any metal to metal contact between the transport object 27 and the lateral support beam 35. Both angled support beams 34 are affixed to a base 15 at the ends of the angled support beams 34 that are opposite the lateral support beam 35. This orientation of lateral support beams 35, angled support beams 34 and base 15 create a V-type frame 2, which is shown in detail in FIG. 5B.

In the embodiment shown in FIGS. 1, 2 and 3, the base 15 is pivotably engaged with the front gooseneck 4 about a substantially horizontal axis through base mounts 37 to form base pivots 25. This makes the V-type frame 2 pivotable at its bottom portion through the base pivots 25 and simultaneously pivotable at its top portion via the upper pivots 21. This pivotability of both the top and bottom portions of the V-type frame 2 allows for maximum adjustability when adjusting the length of the adjustable arms 3 to change the ride height of the transport object 27, when loading the transport object 27, when unloading or when simply adjusting the transport object 27.

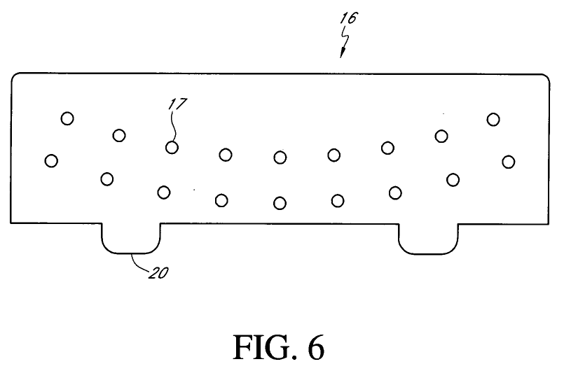

A mounting plate 16 is mechanically engaged with the transport object 27 through mounting plate bolts 18 and mounting plate bolt holes 17. In the embodiment shown in FIG. 6, the mounting plate 16 is constructed with two mounting plate ears 20 and a plurality of mounting plate bolt holes 17 substantially following the shape of the flange of a tower section (not shown). The base 15 is formed with two corresponding base slots 19 of such a dimension and in such a position on the base 15 to accept and engage the mounting plate ears 20 and thereby fix the position of the mounting plate 16, and subsequently the transport object 27, with respect to the base 15. Thereby, the axial dimension of the transport object 27 controls the distance between the front portion 8A and rear portion 8B and dictates the overall length of the Schnable.

In the embodiment shown in FIGS. 1, 2, 3, 4 and 5A, when the hydraulic cylinders 6 are actuated, the base 15 and the angled support beams 34 pivot with respect to the front gooseneck 4 about the base pivots 25, the angled support beams 34 pivot with respect to the adjustable arms 3 about the upper pivots 21, and the adjustable arms 3 pivot with respect to the front gooseneck 4 about the lower pivots 22.

The rear gooseneck 5 is a mirror image to the front gooseneck 4, and operates in essentially the same manner, and in the embodiment shown in FIG. 4 consists of elements that are functionally the same as those of the front gooseneck 4, but mirror images. The rear gooseneck 5 is connected to a multi-axle steering dolly 30, well known to those skilled in the art, via a typical Pintle hitch 26 allowing rock and spin (pivotable simultaneously about a substantially horizontal and vertical axis). At the Pintle hitch 26, one means of coupling said multi-axle steering dolly 30 to a rear gooseneck 12 as recited in the claims, a rear gooseneck tower 12 controls the vertical position of the rear of the rear gooseneck 5 with respect to the multi-axle steering dolly 30 in the same way the front gooseneck tower 11 controls the vertical position of the front of the front gooseneck 4 with respect to the front jeep 7, as is well known to those skilled in the art. A rear gooseneck foot 10 controls the vertical position of the front of the rear gooseneck 5 with respect to the multi-axle steering dolly 30 in the same way the front gooseneck foot 11 controls the vertical position of the rear of the front gooseneck 4 with respect to the front jeep 7. The adjustable arms 3 and base 15 of the rear gooseneck 5 are engaged to the rear gooseneck 5 in the same manner as the adjustable arms 3 and base 15 of the front gooseneck 4 are engaged to the front gooseneck 4. The adjustable arms 3 and base 15 are also pivotable with respect to the rear gooseneck 5 in the same manner as the corresponding elements in the front gooseneck 4 are pivotable with respect to the front gooseneck 4. The lateral support beam 35 and angled support beams 34 of the rear gooseneck 5 are affixed in the same manner as the corresponding elements of the front gooseneck 4 are affixed, and are pivotable with respect to rear gooseneck 4 and elements thereof in the same manner as the corresponding front gooseneck 4 elements are pivotable with respect to the front gooseneck 4 and elements thereof.

The rear gooseneck 5 is engaged with the multi-axle steering dolly 30 via a typical Pintle hitch 26. In the embodiment shown in FIGS. 1, 2 and 4, the multi-axle steering dolly 30 consists of five axles. The forward three axles are fixed, referred to as fixed axles 38, and the rearward two axles are mounted on a turntable 33, referred to as rotatable axles 39, rotatable about a vertical axis with respect to the fixed axles 38, as is well known to those skilled in the art. In the embodiment shown in FIGS. 1, 2 and 4, the angle of the rotatable axles 39 mounted on the turntable 33 with respect to the fixed axles 38 is determined either by a steering arm (not shown) or by hydraulic cylinders 6, as is well known to those skilled in the art.

### OPERATION

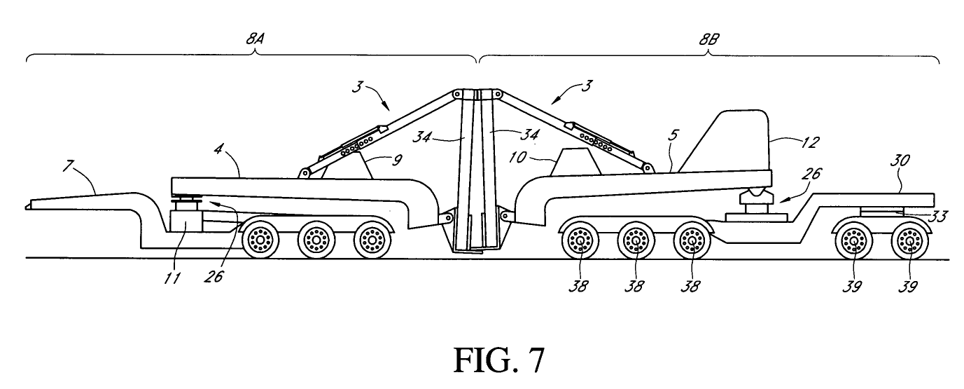

In normal operation of the embodiment shown in FIGS. 1-7, the transport object 27 is fitted with mounting plates 16 at each end. The adjustable arms 3 of both the front gooseneck 4 and the rear gooseneck 5 are retracted so that they are of the least length allowable, the front gooseneck tower 11 and the rear gooseneck tower 12 are lowered and the front gooseneck foot 8 and the rear gooseneck foot 9 are retracted so that the front gooseneck 4 and rear gooseneck 5 are as low as possible with respect to the front jeep 7 and the multi-axle steering dolly 30, respectively. The transport object 27 is then lifted onto the front and rear portions of the Schnable by external equipment so that the mounting plate ears 20 of the mounting plate 16 attached to the rear of the transport object 27 fit into the base slots 19 in the base 15 of the rear gooseneck 5 and the mounting plate ears 20 of the mounting plate 16 attached to the front of the transport object 27 fit into the base slots 19 in the base 15 of the front gooseneck 4. Engagement of the mounting plate ears 20 with the base slots 19 substantially fixes the position of the bottom of the transport object 27 with respect to the front portion 8A and rear portion 8B of the Schnable, whereas the length of the transport object 27 dictates the length of the Schnable when transporting the transport object 27.

The adjustable arms 3 on the front gooseneck 4 and the rear gooseneck 5 are then extended via the hydraulic cylinders 6, one means of adjusting said adjustable arms 3, as recited in the claims, until the wooden pads 36 on each lateral support beam 35 are touching the respective ends of the transport object 27 and a pin 31 is inserted through the pins holes 32 of each adjustable arm 3. If the pin holes 32 of the inner box-shaped member 13 and the outer box-shaped member 14 do not align, the adjustable arms 3 are lowered until two pin holes 32 align, and the pin 31 is inserted at that pin hole 32 to fix the length of the lift arms 3.

At this point, the front gooseneck tower 11 and rear gooseneck tower 12 are raised. Raising the front gooseneck tower 11 and rear gooseneck tower 12 when the position of the bottom of the transport object 27 is fixed by the engagement of the mounting plate ears 20 with the base slots 19 (thereby fixing the axial distance between the base 15 of the front gooseneck 4 and the base 15 of the rear gooseneck 5) causes the lateral support beam 35 on both the front gooseneck 4 and rear gooseneck 5 to move towards the transport object 27. This occurs due to pivoting primarily at the base pivots 25 and both upper pivots 21 on both the front gooseneck 4 and rear gooseneck 5. Once the wooden pads 36 have fully engaged the transport object 27, the transport object 27 is held secure by a compression force, and further raising of the front gooseneck tower 11 and rear gooseneck tower 12 will cause the transport object 27 to lift higher with respect to the front jeep 7 and the multi-axle steering dolly 30, rather than cause the lateral beams 35 to move towards the transport object 27. In this way, the length of the adjustable arms 3 can be adjusted to control the ride height of the transport object 27.

The shorter the adjustable arms 3 are adjusted, the higher the front gooseneck tower 11 and rear gooseneck tower 12 will have to be raised before the wooden pads 36 engage the transport object 27. Before the wooden pads 36 have engaged the transport object 27, raising the front gooseneck tower 11 causes the base 15 to pivot at the base pivots 25 so that the elevation of the base slots 19 (and hence the elevation of the mounting plate 16 and the transport object 27) is lowered. The longer the adjustable arms 3 are adjusted, the lower the front gooseneck tower 11 and rear gooseneck tower 12 will have to be raised before the wooden pads 36 to engage the transport object 27, thus causing the transport object 27 to ride at a higher elevation due to minimal pivoting of the base 15 towards the ground surface before the wooden pads 36 have engaged the transport object 27. Adjusting the adjustable arms 3 to the longest allowable length and increasing the ride height of the transport object 27 facilitates movement of the Schnable over objects on the road or uneven surfaces on the roadway. Adjusting the adjustable arms 3 to the shortest allowable length and decreasing the ride height of the transport object 27 facilitates movement of the Schnable under viaducts, highline wires or any other obstacle associated with tall vehicles or cargo.

Because both the front gooseneck 4 and rear gooseneck 5 are respectively mounted to the front jeep 7 and multi-axle steering dolly 30 on typical Pintle hitches 26 with an axis of pivot substantially in the vertical plane in cooperation with an axis of pivot substantially in the horizontal plane, the length of the lift arms 3 on the front gooseneck 4 and rear gooseneck 5 need not be equal. Rather, the ride height of the transport object 27 may be adjusted merely by adjusting the length of the lift arms 3 on the front gooseneck 5. In this case, the discrepancy in adjustable arm 3 length between the adjustable arms 3 on the rear gooseneck 6 and the adjustable arms 3 on the front gooseneck 5 will be accounted for by the pivoting of the front gooseneck 5 about the Pintle hitch 26 on the front jeep 7 coupled with the pivoting of the rear gooseneck 6 about the Pintle hitch 26 on the multi-axle steering dolly 30, both pivoting about an axis substantially in the horizontal plane, in combination with the pivoting of the base 15 and lateral support beam 35 of both the front gooseneck 5 and rear gooseneck 6 about an axis substantially in the horizontal axis at the respective upper pivots 21 and base pivots 25.

When the transport object 27 is disengaged from the front portion 8A and rear portion 8B of the Schnable, the front portion 8A and rear portion 8B are subsequently mechanically engaged with each other for empty transport, often through chains. In the embodiment shown in FIG. 6, this configuration is used to transport the Schnable when the transport object 27 is no longer engaged with the Schnable.

It should be noted that the present invention is not limited to the specific embodiments pictured and described herein, but is intended to apply to all similar apparatuses incorporating a Schnable with adjustable length adjustable arms 3 to control the transport object 27 ride height and Schnables constructed in such a geometry for appropriately centering the load. Accordingly, modifications and alterations from the described embodiments will occur to those skilled in the art without departure from the spirit and scope of the present invention.

What is claimed is:

1. A Schnable trailer comprising:
a. a front jeep, wherein said front jeep includes a Pintle hitch;
b. a front gooseneck connected to said front jeep via said Pintle hitch, wherein said front gooseneck further comprising:
i. a front tower for controlling the vertical elevation of the front of said front gooseneck with respect to said front jeep;
ii. a front foot for controlling the vertical elevation of the rear of said front gooseneck with respect to said front jeep;
iii. a plurality of mounts;
iv. a plurality of adjustable arms, wherein each of said adjustable arms are formed from a inner box-shaped member fitted inside a outer box-shaped member so that the said first box-shaped member is slideable within said second box-shaped member;
v. a plurality of corresponding holes in said inner box-shaped member and said outer box-shaped member;
vi. a plurality of pins, wherein said pins fit inside said corresponding holes so as to fix the position of said inner box-shaped member with respect to the position of said outer box-shaped member;
vii. a plurality of hydraulic cylinders, wherein a first end of one of said hydraulic cylinders is affixed to said inner box-shaped memberand a second end of on of said hydraulic cylinders is affixed to said outer box-shaped member;
viii. a plurality of lower pivots, wherein one of said lower pivots is formed through the pivotable engagement of a first end of one said adjustable arms with one of said mounts affixed to said front gooseneck;
ix. a base;
x. a mounting plate, wherein said mounting place is engageable with said base through a plurality of slots in said base and a plurality of corresponding ears on said mounting plate;
xi. a plurality of base pivots, wherein a base pivot is formed through the pivotable engagement of said base with one of said mounts affixed to said front gooseneck;
xii. a plurality of angled support beams, wherein a first end of one of said angled support beams is affixed to said base;
xiii. a lateral support beam, wherein said lateral support beam is affixed to a second end of said angled support beams;
xiv. a plurality of wooden pads, wherein said wooden pads are affixed to said lateral support beam;
xv. a plurality of upper pivots, wherein one of said upper pivots is formed through the pivotable engagement of a second end of one of said adjustable arms with one of said mounts affixed to said lateral support beam; and
c. a multi-axle steering dolly, wherein said multi-axle steering dolly includes a Pintle hitch;
d. a rear gooseneck connected to said multi-axle steering dolly via said Pintle hitch, wherein said rear gooseneck further comprising;
i. a rear tower for controlling the vertical elevation of the rear of said rear gooseneck with respect to said multi-axle steering dolly;
ii. a rear foot for controlling the vertical elevation of the front of said rear gooseneck with respect to said multi-axle steering dolly;
iii. a plurality of mounts;
iv. a plurality of adjustable arms, wherein each of said adjustable arms are formed from an inner box-shaped member fitted inside a outer box-shaped member so that the said inner box-shaped member is slideable within said outer box-shaped member;
v. a plurality of corresponding holes in said inner box-shaped member and said outer box-shaped member;
vi. a plurality of pins, wherein said pins fit inside said corresponding holes so as to fix the position of said inner box-shaped member with respect to the position of said outer box-shaped member;
vii. a plurality of hydraulic cylinders, wherein a first end of one of said hydraulic cylinders is affixed to said inner box-shaped member and a second end of on of said hydraulic cylinders is affixed to said outer box-shaped member;
viii. a plurality of lower pivots, wherein one of said lower pivots is formed through the pivotable engagement of a first end of one said adjustable arms with one of said mounts affixed to said rear gooseneck;
ix. a base;
x. a mounting plate, wherein said mounting plate is engageable with said base through a plurality of slots in said base and a plurality of corresponding ears on said mounting plate;
xi. a plurality of base pivots, wherein a base pivot is formed through the pivotable engagement of said base with one of said mounts affixed to said rear gooseneck;
xii. a plurality of angled support beams, wherein a first end of one of said angled support beams is affixed to said base;
xiii. a lateral support beam, wherein said lateral support beam is affixed to a second end of said angled support beams;
xiv. a plurality of wooden pads, wherein said wooden pads are affixed to said lateral support beam; and,
xv. a plurality of upper pivots, wherein one of said upper pivots is formed through the pivotable engagement of a second end of one of said adjustable arms with one of said mounts affixed to said lateral support beam; and,
e. wherein said front jeep having said front gooseneck is cooperatively engaged with a first end of a transport object at said lateral support beam on said front gooseneck and said multi-axle steering dolly having said rear gooseneck is cooperatively engaged with a second end of said transport object at said lateral support beam on said rear gooseneck to allow mobile transport of said object.

2. The Schnable set forth in claim 1 wherein said mounting plates are further defined as having a plurality of mounting plate holes for engagement with mounting plate bolts for engaging said mounting plate with a transport object.

3. The Schnable set forth in claim 3 wherein the transport object is further defined as a tower section for a windmill generator.

4. The Schnable set forth in claim 1 wherein said rear gooseneck is further defined as carrying two adjustable arms, said outer box-shaped member is further defined as having three pin holes spaced 4.5 inches apart and said inner box-shaped member is further defined as having eight pin holes spaced 6 inches apart.

5. The Schnable set forth in claim 1 wherein said lateral support beam is further defined as being 10 feet long.

6. The Schnable set forth in claim 1 wherein said angled support beams form a 77 degree angle with the horizontal and are of such a length so that the distance from the base to the lateral support beam is 12 feet and 7 inches.

7. The Schnable set forth in claim 1 wherein said plurality of adjustable arms are not parallel.

8. A Schnable trailer comprising:
a. a front jeep, wherein said front jeep includes a coupling engagement means;
b. a front gooseneck connected to said front jeep via said coupling engagement means, wherein said front gooseneck further comprising:
i. a means for controlling the vertical elevation of the front of said front gooseneck with respect to said front jeep;
ii. a means for controlling the vertical elevation of the rear of said front gooseneck with respect to said front jeep;
iii. a plurality of mounts;
iv. a plurality of adjustable length adjustable arms,
v. a powered means for adjusting the length of said adjustable arms;
vi. a plurality of lower pivots, wherein a lower pivot is formed through the pivotable engagement of a first end of one said adjustable arms with one of said mounts affixed to said front gooseneck;
vii. a base;
viii. a means for securing an transport object to said base;
ix. a plurality of base pivots, wherein a base pivot is formed through the pivotable engagement of said base with one of said mounts affixed to said front gooseneck;
x. a plurality of angled support beams, wherein a first end of said angled support beams is affixed to said base;
xi. a lateral support beam, wherein said lateral support beam is affixed to a second end of said angled support beams;
xii. a plurality of upper pivots, wherein one of said upper pivots is formed through the pivotable engagement of a second end of one of said adjustable arms with one of said mounts affixed to said lateral support beam; and
c. a multi-axle steering dolly, wherein said multi-axle steering dolly includes a coupling engagement means;
d. a rear gooseneck connected to said multi-axle steering dolly via said coupling engagement means, wherein said rear gooseneck further comprising;
i. a means for controlling the vertical elevation of the rear of said rear gooseneck with respect to said multi-axle steering dolly;
ii. a means for controlling the vertical elevation of the front of said rear gooseneck with respect to said multi-axle steering dolly;
iii. a plurality of mounts;
iv. a plurality of adjustable arms;
v. a powered means for adjusting the length of said adjustable arms;
vi. a plurality of lower pivots, wherein one of said lower pivots is formed through the pivotable engagement of a first end of one said adjustable arms with one of said mounts affixed to said rear gooseneck;
vii. a base;
viii. a mounting plate, wherein said mounting plate is engageable with said base through a plurality of slots in said base and a plurality of corresponding ears on said mounting plate;
ix. a plurality of base pivots, wherein a base pivot is formed through the pivotable engagement of said base with one of said mounts affixed to said rear gooseneck;
x. a plurality of angled support beams, wherein a first end of one of said angled support beams is affixed to said base;
xi. a lateral support beam, wherein said lateral support beam is affixed to a second end of said angled support beams; and,
xii. a plurality of upper pivots, wherein one of said upper pivots is formed through the pivotable engagement of a second end of one of said adjustable arms with one of said mounts affixed to said lateral support beam.

9. The Schnable set forth in claim 8 wherein said mounting plates are further defined as having a plurality of mounting plate holes for engagement with mounting plate bolts for engaging said mounting plate with a transport object.

10. The Schnable set forth in claim 9 wherein the transport object is further defined as a tower section for a windmill generator.

11. The Schnable set forth in claim 8 wherein said rear gooseneck is further defined as carrying two adjustable arms, said outer box-shaped member is further defined as having three pin holes spaced 4.5 inches apart and said inner box-shaped member is further defined as having eight pin holes spaced 6 inches apart.

12. The Schnable set forth in claim 8 wherein said lateral support beam is further defined as being 10 feet long.

13. The Schnable set forth in claim 8 wherein said angled support beams form a 77 degree angle with the horizontal and are of such a length so that the distance from the base to the lateral support beam is 12 feet and 7 inches.

14. The Schnable set forth in claim 8 wherein said plurality of adjustable arms are not parallel.
